(19) United States
(12) Patent Application Publication
(10) Pub. No.: US 2025/0382968 A1
(43) Pub. Date: Dec. 18, 2025

(54) SYSTEM AND METHOD OF SETTING FAN WEIGHTS BASED ON EVOLUTIONARY STRATEGY

(71) Applicants: INVENTEC (PUDONG) TECHNOLOGY CORPORATION, Shanghai (CN); INVENTEC CORPORATION, Taipei City (TW)

(72) Inventors: Chien-Ming LEE, Taipei City (TW); Kai-Yang TUNG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/944,919

(22) Filed: Nov. 12, 2024

(30) Foreign Application Priority Data
Jun. 14, 2024 (CN) 202410775270.3

(51) Int. Cl. F04D 27/00; G05B 13/02

(52) U.S. Cl. CPC F04D 27/005; F04D 27/001; G05B 13/0265

(57) ABSTRACT

A method of setting fan weights based on evolutionary strategy, performed by a computing element, includes: generating first weight combinations randomly, each of the first weight combinations including weights configured to set operation parameters of fans, conducting a fan control test using the first weight combinations and receiving test results, calculating fitness values with a fitness function according to the first weight combinations and the test results, selecting candidate weight combinations from the first weight combinations, with the candidate weight combinations corresponding to lowest fitness values among the fitness values, generating second weight combinations according to the candidate weight combinations using a covariance matrix adaptation evolution strategy (CMA-ES) algorithm, and using one of the second weight combinations to control the fans when a generation number corresponding to the second weight combinations reaches a threshold value.

### CROSS-REFERENCE TO RELATED APPLICATIONS

This non-provisional application claims priority under 35 U.S.C. § 119 (a) on Patent Application No(s). 202410775270.3 filed in China on Jun. 14, 2024, the entire contents of which are hereby incorporated by reference.

### BACKGROUND

### 1. Technical Field

This disclosure relates to power consumption control of fans, especially to a system and method of setting fan weights based on evolutionary strategy.

### 2. Related Art

In recent years, the issue of energy consumption in server fans has received increasing attention. To address this problem, various methods have been proposed to manage the operation of multiple fans within a server.

Synchronous control is a common method, where the calculated required speed signal is synchronously output to all system fans. However, synchronous control may lead to unnecessary fan energy consumption, as it cannot effectively differentiate the cooling requirements of all hotspots in the system. This causes all fans to operate at the same speed, even if the cooling demand in certain areas is lower.

In 2013, Intel proposed a fan weighting method, which introduced the concept of an output weight matrix to distinguish the correlation between the relative positions of the server system's hotspots and the fans. For example, multiple hotspots within the server system are treated as temperature points, and weight values are assigned based on the relative position of each temperature point to multiple fans. However, improper weight settings can cause significant fluctuations in fan speeds. Additionally, with the large number of sensors in servers, multiple temperature points corresponding to multiple fans make the configuration of the output weight matrix quite complex. Managing the intricate relationships between numerous temperature points and fans poses a challenge. Moreover, the current multi-fan weight settings are often determined based on human experience, and there are even cases where all weights are set to the same value, which essentially reverts to the synchronous control method.

Overall, there is currently a lack of methods for optimizing the weight settings, leading to unnecessary energy consumption by server fans most of the time.

### SUMMARY

Accordingly, this disclosure provides a system and method of setting fan weights based on evolutionary strategy to solve the above problems.

According to one or more embodiment of this disclosure, a method of setting fan weights based on evolutionary strategy, performed by a computing element, includes: generating a plurality of first weight combinations randomly, each of the plurality of first weight combinations including a plurality of weights configured to set a plurality of operation parameters of a plurality of fans; conducting a fan control test using the plurality of first weight combinations and receiving a plurality of test results; calculating a plurality of fitness values of the plurality of first weight combinations and the plurality of test results according to a fitness function; selecting a plurality of candidate weight combinations from the plurality of first weight combinations, with the plurality of candidate weight combinations corresponding to lowest fitness values among the plurality of fitness values; generating a plurality of second weight combinations according to the plurality of candidate weight combinations using a covariance matrix adaptation evolution strategy (CMA-ES) algorithm; and using one of the plurality of second weight combinations to control the plurality of fans when a generation number corresponding to the plurality of second weight combinations reaches a threshold value.

According to one or more embodiment of this disclosure, a system of setting fan weights based on evolutionary strategy is adapted to a server having a plurality of fans. The system includes a storage element and a computing element. The storage element is configured to store a plurality of test results generated by the server conducting a fan control test using a plurality of first weight combinations. Each of the plurality of first weight combinations includes a plurality of weights corresponding to the plurality of fans, and the plurality of weights are configured to set a plurality of operation parameters of the plurality of fans. The computing element is electrically connected to the storage element and the server. The computing element is configured to generating the plurality of first weight combinations randomly, calculate a plurality of fitness values of the plurality of first weight combinations and the plurality of test results according to a fitness function, select a plurality of candidate weight combinations from the plurality of first weight combinations with the plurality of candidate weight combinations corresponding to lowest fitness values among the plurality of fitness values, generate a plurality of second weight combinations according to the plurality of candidate weight combinations using a covariance matrix adaptation evolution strategy (CMA-ES) algorithm, and use one of the plurality of second weight combinations to control the plurality of fans when a generation number corresponding to the plurality of second weight combinations reaches a threshold value.

In view of the above description, the present disclosure proposes a system and method of setting fan weights based on evolutionary strategy in genetic algorithms, which may generate the most energy-efficient fan weight settings. Current fan management configuration methods mostly use partitioned weight settings, requiring each fan's weight to be set for every temperature sensing point inside the server, resulting in a large number of parameters, making the verification process quite challenging. The method proposed by the present disclosure may automatically find the optimal solution for the combination of fan weights, saving time and making it easier to implement. The method proposed in the present disclosure has been repeatedly tested and evaluated, confirming that the search approach has a solid theoretical foundation. The method and system proposed in the present disclosure may improve the performance of fan control and reduce unnecessary energy consumption. Actual verification shows that fan energy consumption may be reduced by more than 40%.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of an example of a server adapted to the present disclosure;

FIG. 2 is a structural block diagram illustrating of a system of setting fan weights based on evolutionary strategy according to an embodiment of the present disclosure;

FIG. 3 is a flow chart illustrating of a method of setting fan weights based on evolutionary strategy according to an embodiment of the present disclosure; and

FIG. 4 shows schematic diagrams of experiment results of the method proposed in the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

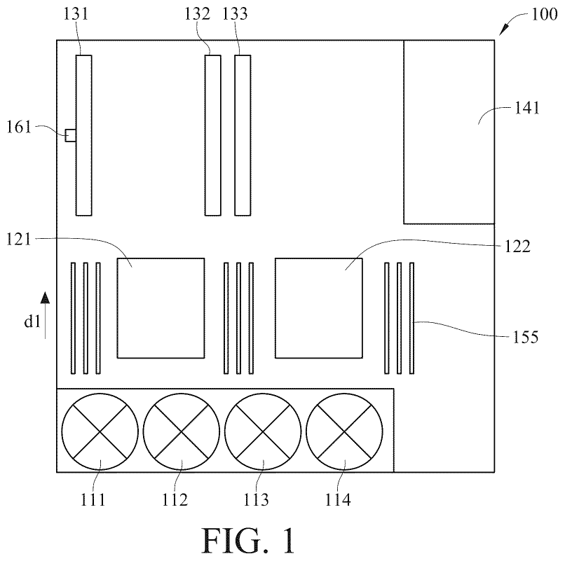

The present disclosure proposes a system and method of setting fan weights based on evolutionary strategy. FIG. 1 is a structural schematic diagram of a server having a plurality of fans adapted to the present disclosure. As shown in FIG. 1, the server 100 includes fans 111 to 114, processors 121 and 122, bus cards 131 to 133, a power supply 141, a memory 155 and a thermocouple 161, wherein a wind direction provided by the fans 111 to 114 is as shown by a direction d1. In an embodiment, the bus cards 131 to 133 may be PCIe (peripheral component interconnect express) cards. The thermocouple 161 is disposed on the bus card 131 for sensing a temperature of the bus card 131. It should be noted that the configuration of the server 100 adapted to the present disclosure is not limited to the example shown in FIG. 1.

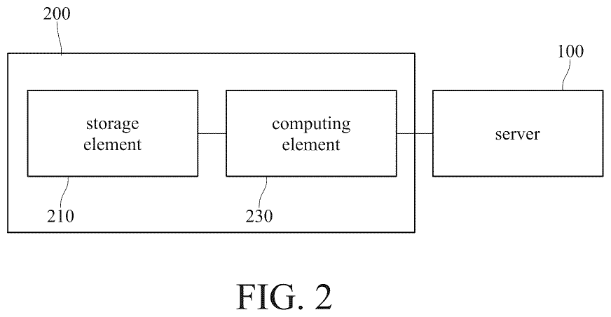

FIG. 2 is a structural block diagram illustrating of a system of setting fan weights based on evolutionary strategy according to an embodiment of the present disclosure. As shown in FIG. 2, the system 200 of setting fan weights based on evolutionary strategy includes a storage element 210 and a computing element 230.

The storage element 210 is configured to store a plurality of test results of the fans 111 to 114 of the server 1000 generated by conducting a fan control test according to a plurality of first weight combinations. The first weight combinations include weights corresponding to the fans 111 to 114, and the weights are configured to set operation parameters of the fans 111 to 114.

In an embodiment, the storage element 210 may be implemented by using at least one of the following examples: a flash memory, a hard disk drive (HDD), a solid-state drive (SSD), a dynamic random-access memory (DRAM), a static random-access memory (SRAM) or any other non-volatile memory. The present disclosure is not limited to the above examples.

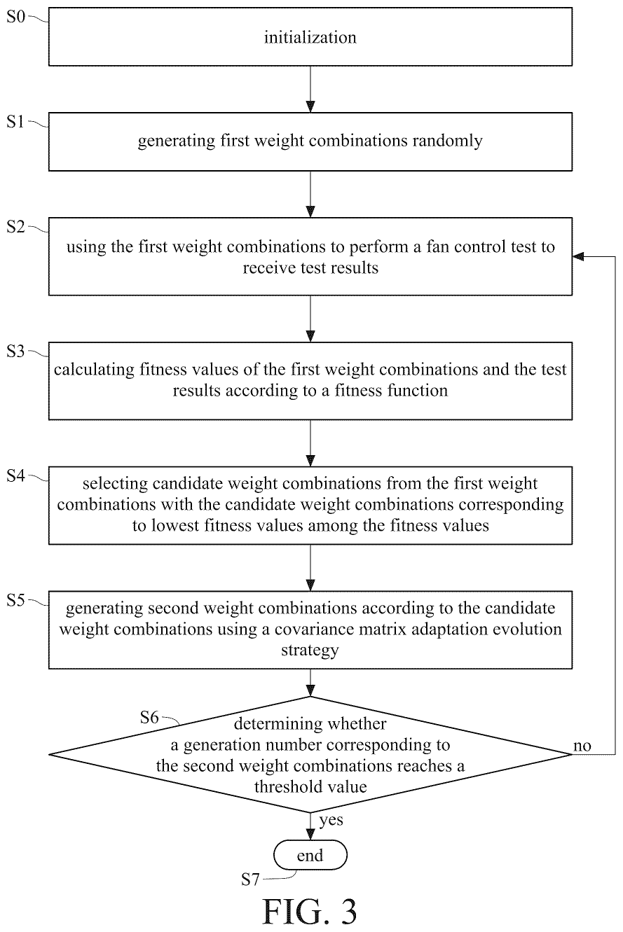

The computing element 230 is electrically connected to the storage element 210 and the server 100, thereby setting the weights and receiving the test results. In an embodiment, the computing element 230 may be implemented by using at least one of the following examples: a microcontroller (MCU), an application processor (AP), a field programmable gate array (FPGA), an application specific integrated circuit (ASIC) system-on-a-chip (SOC), a deep learning accelerator or any other electronic device with similar functions. The present disclosure is not limited to the above examples. The following uses the flow chart of FIG. 3 to explain the steps performed by the computing element 230.

FIG. 3 is a flow chart illustrating of a method of setting fan weights based on evolutionary strategy according to an embodiment of the present disclosure. As shown in FIG. 3, the method includes steps S1 to S7 performed by the computing element 230. In an embodiment, steps S1 to S7 are stored in the storage element 210 in the form of MATLAB source codes, and the computing element 230 executes the source codes to implement steps S1 to S7.

In the initialization of step S0, a user designates the number of fans (for example, 4) and sets the range of the weights (for example, five selectable weights of 0.2, 0.4, 0.6, 0.8 and 1.0) on the computing element 230. The weights represents the correlation between the server hotspots and the locations of the fans. The weights generally are values between 0 and 1, wherein value 0 represents the situation of no correlation, and value 1 represents the situation of complete positive correlation.

In step S1, the computing element 230 generates the first weight combinations randomly as an offspring of a first generation in the evolutionary strategy. Each first weight combination includes a plurality of weights, and the weights are used to set the operation parameters of the fans 111 to 114. Take the server 100 of FIG. 1 as an example, for the processor 121, one first weight combination corresponding to the fans 111 to 114 may be [1, 0.8, 0.6, 0.4]. It should be noted that in the first weight combination, at least one of the weights is 1, which represents that at least one fan (for example, fan 111) runs at full speed.

Continuing from the above example, the number of the fans being 4 is equivalent to the search space based on the evolutionary strategy being n=4. In an embodiment, if the number of the first weight combinations is λ, the number of the fans is n, then λ=n+floor(3 ln(n)), wherein floor( ) is a floor function, and In( ) is a logarithmic function.

In step S2, the computing element 230 uses the first weight combinations to perform a fan control test to receive the test results. In detail, the computing element 230 each time inputs one first weight combination to the fans 111 to 114 of the server 100 for testing. The test result includes an ideal control duration, an actual control duration and total fan power, and whether the server 100 meets the temperature norm during operation, such as the temperature measured by the thermocouple 161 exceeds a threshold. Examples of not meeting the temperature norm includes, but not limited to: the control result diverges, causing the rotational speed to fail to stabilize; the transient temperature during the control process exceeds a certain threshold above the setpoint (e.g., more than 5° C.); the steady-state temperature error during the control process exceeds a certain threshold (e.g., more than 2%). As for examples that meet the temperature norm: the control process is stable, and the steady-state temperature error is below a certain threshold.

In step S3, the computing element 230 calculates a plurality of fitness values of the first weight combinations and the test results according to a fitness function. In an embodiment, after adopting the weights of the first weight combinations to set the operation parameters of the fans 111 to 114, the fitness function is a value of subtracting the actual control duration from the ideal control duration and adding the total fan power when the server 100 detects the situation of not meeting the temperature norm (for example, the temperature measured by the thermocouple 161 is higher than the threshold). In detail, the more the first weight combinations deviates from the server 100 (does not fit the operation of the server 100), the difference between the actual control duration and the ideal control duration is greater, the fitness values is accordingly greater, thereby causing the first weight combination to more likely be excluded from the following selection. In another embodiment, the fitness function adopts fan power consumption if the weights of the first weight combinations meet the temperature norm (for example, the temperature measured by all temperature sensors in the server 100 are lower than the threshold).

In step S4, the computing element 230 selects a plurality of candidate weight combinations from the first weight combinations, with the candidate weight combinations corresponding to lowest fitness values among the fitness values. In an embodiment, if the number of the candidate weight combinations is μ, then

$$μ = floor ( \frac{λ}{2} ) .$$

Step S4 corresponds to parent selection in the evolutionary strategy. That is, the fitness values of the previous generation are sorted from the lowest value to the highest value, the first weight combinations corresponding to μ fitness values with the lowest values (that are sorted at the front) are selected, and the selected first weight combinations are used as the candidate weight combinations.

In step S5, the computing element 230 generates a plurality of second weight combinations according to the candidate weight combinations using a covariance matrix adaptation evolution strategy (CMA-ES) algorithm and adds one to the generation count. CMA-ES adopts update mechanism such as parent mean, covariance matrix, global mutation step size and evolution path etc. Therefore, the convergence speed of evolution is significantly enhanced, thereby implementing a more efficient search through correlated mutations, making it one of the commonly used algorithms for engineering parameter optimization.

In step S6, the computing element 230 determines whether the generation number corresponding to the second weight combinations reaches a threshold value. In an embodiment, the threshold value of the generation number is, for example, set as 10, but the present disclosure is not limited thereto.

If the determination result of step S6 is “yes”, step S7 is then performed. In step S7, the computing element 230 outputs one of the second weight combinations, and then the method ends. In an embodiment, the computing element 230 outputs one of the second weight combinations corresponding to the smallest fitness value.

If the determination result of step S6 is “no”, the computing element 230 uses the second weight combinations generated in step S5 as the new first weight combinations, and adds one to the current generation, and then performs step S2 again to perform the fan control test with the weight combinations of the next generation.

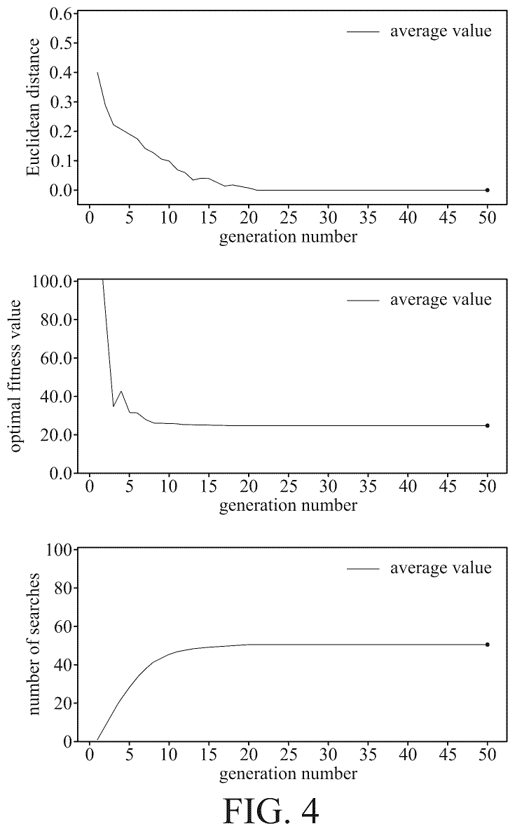

FIG. 4 shows schematic diagrams of experiment results of the method proposed in the present disclosure. Table 1 below is the experiment results under two different system loads according to the method proposed in the present disclosure. Please refer to FIG. 4, in the 30 repeated tests, the results all show that the fan's power consumption approaches the lowest level. Due to the random nature of the evolutionary process, 30 repeated tests are conducted to demonstrate that each re-evolution converges towards the same goal (minimization of power consumption). In FIG. 4, the result of the Euclidean distance mean±standard deviation is 0.0+0.0, indicating that the evolutionary convergence has been completed. The result of the average±standard deviation for the optimal fitness value is 25.2±1.4, which corresponds to the steady-state fan power consumption. The result of the average±standard deviation for the number of distinct weight searches is 52±8, meaning that the algorithm finds the optimal value after only searching 52 out of all possible (369 in this experiment) solutions.

Table 1 shows the experiment results under different system loads, wherein the configuration of case A is the loads of CPU0, CPU1, PCIE0 and PCIE1 are all 100%, and the configuration of case B is the loads of CPU0 and CPU1 are both 100%, and the loads of PCIE0 and PCIE1 are both 60%.

| | | case A | case B |
|---|---|---|---|
| Multi-fan control | Number of distinct weight searches | 52 ± 8 | 50 ± 7 |
| system (30 rounds | (average ± standard deviation) | | |
| of repeated tests, | Best total power | 22.7 W | 22.7 W |
| with total of 369 | Median total power | 26.0 W | 22.9 W |
| weights options) | Worst total power | 26.2 W | 30. W |
| | Average total power | 25.2 W | 24.7 W |
| | Average energy savings | 39.5% | 40.7% |
| | (relative synchronous control) | | |

| | | |
|---|---|---|
| Total power of synchronous control | 41.6 W | 41.6 W |

In view of the above, the present disclosure proposes a system and method of setting fan weights based on evolutionary strategy in genetic algorithms, which may generate the most energy-efficient fan weight settings. Current fan management configuration methods mostly use partitioned weight settings, requiring each fan's weight to be set for every temperature sensing point inside the server, resulting in a large number of parameters, making the verification process quite challenging. The method proposed by the present disclosure may automatically find the optimal solution for the combination of fan weights, saving time and making it easier to implement. The method proposed in the present disclosure has been repeatedly tested and evaluated, confirming that the search approach has a solid theoretical foundation. The method and system proposed in the present disclosure may improve the performance of multi-fan control and reduce unnecessary energy consumption. Actual verification shows that fan energy consumption may be reduced by more than 40%.

In an embodiment of the present disclosure, the method of setting fan weights based on evolutionary strategy may be applied to a server, and the server may be applied to artificial intelligence (AI) computing, edge computing. The server may also be used as a 5Gth server, a cloud server or a vehicle-to-everything server.

What is claimed is:

1. A method of setting fan weights based on evolutionary strategy, performed by a computing element, comprising:
generating a plurality of first weight combinations randomly, each of the plurality of first weight combinations including a plurality of weights configured to set a plurality of operation parameters of a plurality of fans;
conducting a fan control test using the plurality of first weight combinations and receiving a plurality of test results;
calculating a plurality of fitness values of the plurality of first weight combinations and the plurality of test results according to a fitness function;
selecting a plurality of candidate weight combinations from the plurality of first weight combinations, with the plurality of candidate weight combinations corresponding to lowest fitness values among the plurality of fitness values;
generating a plurality of second weight combinations according to the plurality of candidate weight combinations using a covariance matrix adaptation evolution strategy (CMA-ES) algorithm; and
using one of the plurality of second weight combinations to control the plurality of fans when a generation number corresponding to the plurality of second weight combinations reaches a threshold value.

2. The method of setting fan weights based on evolutionary strategy according to claim 1, wherein the fitness function is associated with an ideal control duration, an actual control duration and total fan power when one of the plurality of test results fails.

3. The method of setting fan weights based on evolutionary strategy according to claim 1, wherein the fitness function is associated with fan consumption power when one of the plurality of test results passes.

4. The method of setting fan weights based on evolutionary strategy according to claim 1, wherein a number of the plurality of first weight combinations is λ, a number of the plurality of fans is n, and λ=n+floor(3 ln(n)).

5. The method of setting fan weights based on evolutionary strategy according to claim 4, wherein a number of the plurality of candidate weight combinations is μ, and
$$μ = floor ( \frac{λ}{2} ) .$$

6. A system of setting fan weights based on evolutionary strategy, adapted to a server having a plurality of fans, the system comprising:
a storage element configured to store a plurality of test results generated by the server conducting a fan control test using a plurality of first weight combinations, wherein each of the plurality of first weight combinations includes a plurality of weights corresponding to the plurality of fans, and the plurality of weights are configured to set a plurality of operation parameters of the plurality of fans; and
a computing element electrically connected to the storage element and the server, the computing element configured to generating the plurality of first weight combinations randomly, calculate a plurality of fitness values of the plurality of first weight combinations and the plurality of test results according to a fitness function, select a plurality of candidate weight combinations from the plurality of first weight combinations with the plurality of candidate weight combinations corresponding to lowest fitness values among the plurality of fitness values, generate a plurality of second weight combinations according to the plurality of candidate weight combinations using a covariance matrix adaptation evolution strategy (CMA-ES) algorithm, and use one of the plurality of second weight combinations to control the plurality of fans when a generation number corresponding to the plurality of second weight combinations reaches a threshold value.

7. The system of setting fan weights based on evolutionary strategy according to claim 6, wherein the fitness function is associated with an ideal control duration, an actual control duration and total fan power when one of the plurality of test results fails.

8. The system of setting fan weights based on evolutionary strategy according to claim 6, wherein the fitness function is associated with fan consumption power when one of the plurality of test results passes.

9. The system of setting fan weights based on evolutionary strategy according to claim 6, wherein a number of the plurality of first weight combinations is λ, a number of the plurality of fans is n, and λ=n+floor(3 ln(n)).

10. The system of setting fan weights based on evolutionary strategy according to claim 6, wherein a number of the plurality of candidate weight combinations is μ, and
$$μ = floor ( \frac{λ}{2} ) .$$
